(19) United States
(12) Patent Application Publication
(10) Pub. No.: US 2024/0396334 A1
(43) Pub. Date: Nov. 28, 2024

(54) Load Sharing Apparatus and Method

(71) Applicant: Alex Quon, Halifax (CA)

(72) Inventor: Alex Quon, Halifax (CA)

(21) Appl. No.: 18/202,761

(22) Filed: May 26, 2023

(51) Int. Cl. H02J 3/14; B60L 53/16

(52) U.S. Cl. CPC H02J 3/14; B60L 53/16; H02J 2310/48

(57) ABSTRACT

A load sharing apparatus and method to switch power between an electrical vehicle charger and a household appliance. The apparatus includes having an electrical plug configured to engage with an external electrical socket, an EV charger component in electrical power communication with the electrical plug, an internal electrical output configured to connect a household appliance and is in selected electrical power communication with the electrical plug via a power switching component. The method includes detecting a power load upon the internal electrical output. When no power is detected, to provide power to the EV charger component. When power is detected upon the internal electrical output, switch the power from the EV charger component to the internal electrical output, and then return power back to the EV charger component when the positive power load on the internal electrical output is no longer detected.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of electrical load sharing and more specifically relates to an apparatus and method for load sharing between an electrical vehicle charger and a second electrical device.

### RELATED ART

Electric vehicles (EV) are becoming extremely popular with the relevant consumer market growing on a steady basis. These vehicles run on internal batteries that require electrical charging on a regular basis. Most owners of EVs often connect their vehicle to a charging station located within their house or garage.

However, in many cases old homes do not have enough space or capacity in their electrical panels to accommodate an electrical vehicle charger. In such a situation, electrical contractor would have to be hired to install a new sub panel or upgrade the electrical service entirely, which can be expensive and cost prohibitive.

U.S. Pat. No. 9,090,175B2 discloses a power share system for electric vehicle service equipment (EVSE). The system comprises of an electric vehicle service equipment (EVSE) and having power share system for another house load. The system consists of a power share module connects directly with the EVSE and also efficiently installed to interface with a single residential utility. The power share module continuously senses the load level for a high load utility (e.g., range or electric dryer) and when the load current of the utility exceeds a pre-determined threshold, a control board microprocessor sends a closure control command to the EVSE. Further, suspends the electric charging of electric vehicle.

U.S. Pat. No. 11,469,613B2 discloses a system for household electrical management and charging of electric vehicles and/or other high load appliances. The system comprising an electric vehicle service equipment (EVSE) module for charging the EV and having a load-sharing device system for another house load. The load-sharing device shares electrical load between a high-ranking load (e.g., electrical range, a dryer) and a low-ranking load (EVSE). When high-ranking load is drawing power and closes a switch to complete the circuit from DC power supply. Further, when high-ranking load is not drawing current, the switch remains open and delivers current from AC source to the low-ranking load.

U.S. Pat. No. 8,232,765B2 the patent discloses a system with automatic and dynamic home electricity load balancing for the purpose of EV charging. The system comprises of an electric service panel to monitor a total present electric current consumption value for all electric consumers below a point in the service panel. When a vehicle is plugged for charging, the electricity to home appliance is decreased.

While the prior art attempts to provide a solution to the disadvantage of requiring the installation of an expensive EV power system. As such, there is a need for an apparatus and method that provides cost effective EV charging.

### SUMMARY OF THE INVENTION

In view of the foregoing disadvantages inherent in the known EV charging art, the present disclosure provides a novel EV load sharing apparatus and method. The general purpose of the present disclosure, which will be described subsequently in greater detail, is to provide an apparatus and method for EV load sharing system which is cost effective.

A load sharing apparatus is disclosed herein. The apparatus may include a load sharing switching component having an electrical plug and an internal electrical receptacle. The power receptable is configured to receive an electrical plug from a household appliance. An electrical vehicle charger (EV charger) is also in power communication with the load sharing switching component. The EV charger is configured to provide power to an electric vehicle via a power port.

The load sharing switching component may include a power switching component that is configured to detect if there is a power load upon the internal electrical receptacle. When no power load is detected, power switching component provides power to EV charger. However, when a power load is detected, power switching component switches the power from the EV charger 202 to the internal electrical receptacle. Once the power load is no longer detected, power switching component 220 returns power to EV charger.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, constructed and operative according to the teachings of the present disclosure.

FIG. 1 is a schematic block diagram of an apparatus for load sharing, according to an embodiment of the disclosure.

FIG. 2 is a schematic diagram of an apparatus for load sharing with an embodiment of the switch in an open position, according to an embodiment of the present disclosure.

FIG. 3 is a schematic diagram of an apparatus for load sharing with an embodiment of the switch in a closed position, according to an embodiment of the present disclosure.

FIG. 4 is a block diagram of a method for load sharing, according to another embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to load sharing and more particularly to an apparatus and method for load sharing involving an electrical vehicle.

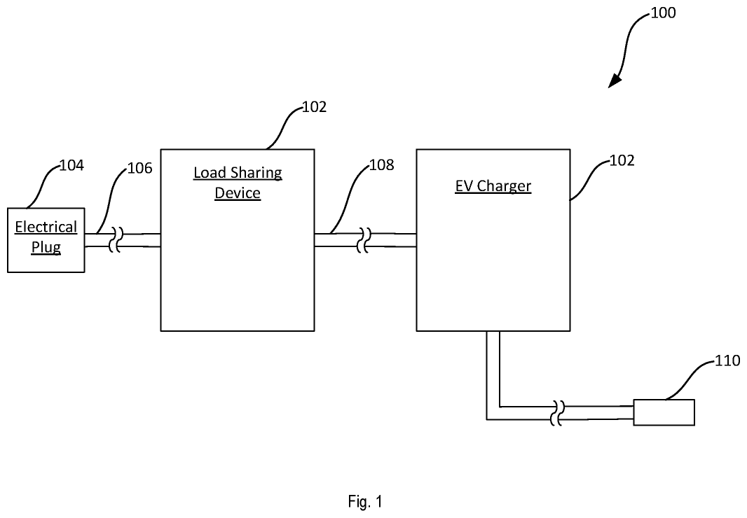

Referring now more specifically to the drawings by numerals of reference, there is shown in FIGS. 1-4, various views and schematic diagrams of an apparatus 100 and load sharing matching method 400. As shown in FIG. 1, an embodiment of an apparatus 100 for load sharing may include a load sharing switching component 101 having an electrical plug 104 in power communication via a first power line 106. The load sharing switching component 101 includes a power receptacle 112. Power receptable 112 is configured to receive an electrical plug from a household appliance.

An electrical vehicle charger (EV charger) 102 is also in power communication with the load sharing switching component 101 via a second power line 108. The EV charger 102 is configured to provide power to an electric vehicle via a power port 110.

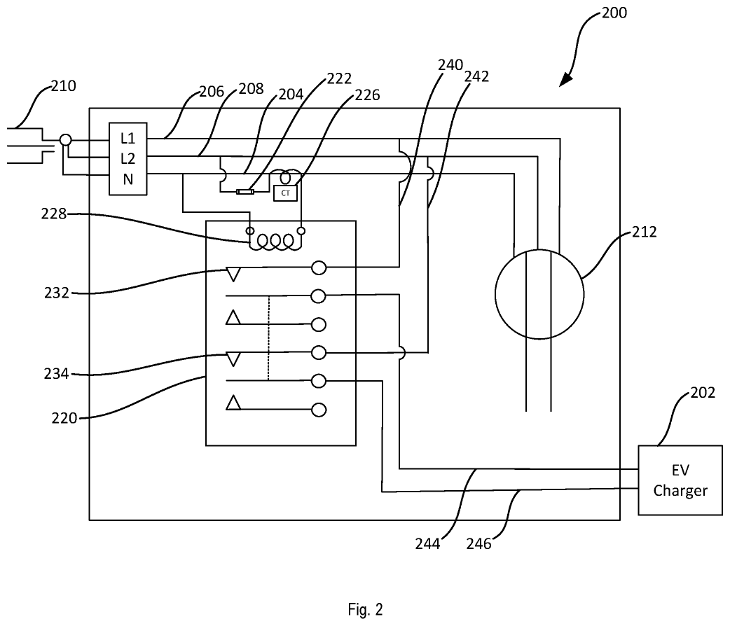

As shown in FIG. 2, an embodiment of the load sharing component 200 is illustrated. Component 200 includes a power switching component 220 and internal electrical receptacle 212. Internal electrical receptacle 212 is configured to engage household appliance the requires periodic power when in use, such as a laundry dryer.

Component 200 is in electrical power communication with an electrical vehicle charger 202 (EV charger). Component 200 is also in electrical power communication with an electrical plug 210 which is configured to engage with an external electrical socket. In this embodiment, internal electrical receptacle 212 and EV charger 202 are in selected electrical power communication with the electrical plug 210 via the power switching component 220.

In this embodiment, power switching component 220 is configured to detect if there is a power load upon the internal electrical receptacle 212. When no power load is detected, power switching component 220 provides power to EV charger 202. However, when a power load is detected, power switching component 220 switches the power from the EV charger 202 to the internal electrical receptacle 212. Once the power load is no longer detected, power switching component 220 returns power to EV charger 202.

In some embodiments, electrical plug 210 is a 220-volt plug to engage a 220-volt receptacle, and includes a first lead line 206, a second lead line 208 and a neutral line 204. First lead line 206, second lead line 204 and neutral line 204 are in electrical power communication with internal electrical receptacle 212.

In some embodiments, power switching component 220 includes a first lead line switch 232 connected the first lead line 206 via a first switch line 240 and a first internal output lead 244 and a second lead line switch 234 connected to the second lead line 208 via a second switch line 242 and a second internal output lead 246. First and second internal output leads 244, 246 provide power to EV charger 202.

A power sensor switch 226 is connected to the neutral line 204 and the second lead 208 for detecting there is a positive power load on the internal electrical receptacle 212.

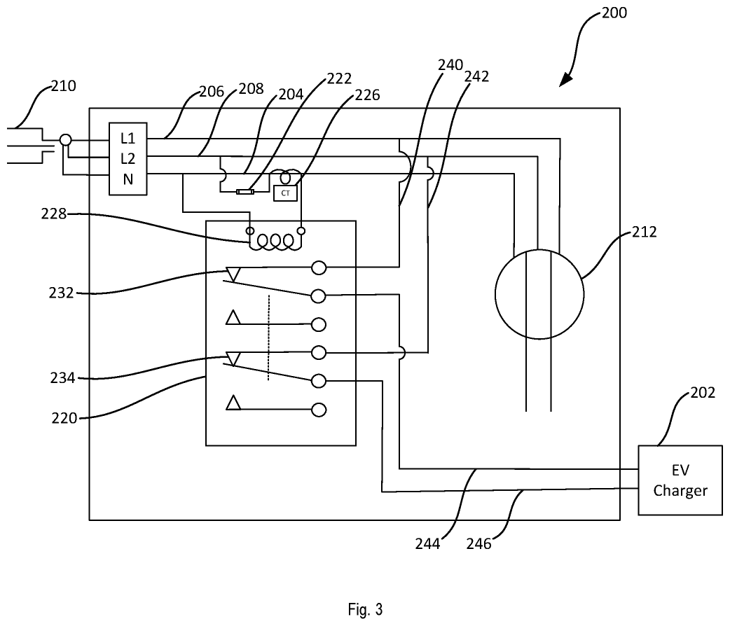

In some embodiments, a contactor 220 includes a first switch 232 and a second switch 234. When no power load is detected from the internal electrical receptacle 212, first and second switches 232, 234 are in a closed position, as illustrated in FIG. 3. This allows power to flow from electrical plug 210 to EV charger 202. However, when a positive power load is detected from internal electrical receptacle 212, first and second switches 232, 234 are changed to an open position, as illustrated in FIG. 2. This allows power to flow to internal electrical receptacle 212.

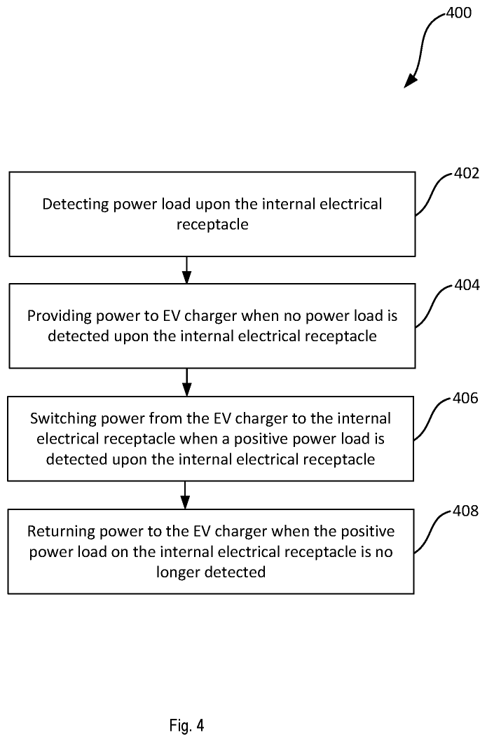

Referring now to FIG. 4 as shown, an embodiment of a load sharing method 400 is disclosed. This method is performed utilizing the apparatus as described above and includes the steps of detecting a first power load upon the internal electrical output, at step 402. When no power load is detected, the method provides power to the EV charger component when no power load is detected upon the internal electrical output, at step 404.

However, when a power load is detected, the power is switched from the EV charger to the internal electrical output, as step 406, and then returned back to the EV charger when the positive power load on the internal electrical output is no longer detected, at step 406.

Whilst the present disclosure specifically discusses the application of the system/method with vehicle/auto loads, it should be appreciated that the system and methods performed by the system may not be limited to solely vehicle/auto loads.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

1. A load sharing apparatus comprising:
an electrical plug configure to engage with an external electrical socket;
an EV charger component in electrical power communication with the electrical plug;
an internal electrical output configured to connect a household appliance and is in selected electrical power communication with the electrical plug via a power switching component,
the power switching component configured to detect power load upon the internal electrical output, and
further configured to provide power to the EV charger component when no power load is detected upon the internal electrical output, and
further configured to switch the power from the EV charger component to the internal electrical output when a positive power load is detected upon the internal electrical output, and to return power to the EV charger component when the positive power load on the internal electrical output is no longer detected.

2. The load sharing apparatus of claim 1, wherein the electrical plug comprising a 220-volt plug and is configured to engage a 220-volt socket, the 220-volt plug being connected to a first lead line, a second lead line and a neutral line, the first lead line, second lead line and neutral line electrical power communication with the internal electrical output.

3. The load sharing apparatus of claim 2, wherein the power switching component comprises:
a first lead line switch connected the first lead line and a first internal output lead;
a second lead line switch connect to the second lead line and the second internal output lead; and
a contactor connected to the neutral line and the second lead for detecting the positive power load by the internal electrical output,
wherein the first internal output lead and second internal output lead connected to the internal electrical output, and
wherein the first internal output lead and the second internal output lead being in electrical power communication with the EV charger component.

4. The load sharing apparatus of claim 1, wherein the internal electrical output comprises a 220-volt socket.

5. A method for load sharing utilizing a device having an electrical plug configured to engage with an external electrical socket, an EV charger component in electrical power communication with the electrical plug, an internal electrical output configured to connect a household appliance and is in selected electrical power communication with the electrical plug via a power switching component, the method comprising the steps of:
detecting a first power load upon the internal electrical output; and
providing power to the EV charger component when no power load is detected upon the internal electrical output;
switching the power from the EV charger component to the internal electrical output when a positive power load is detected upon the internal electrical output; and
returning power to the EV charger component when the positive power load on the internal electrical output is no longer detected.
